(19) United States
(12) Patent Application Publication
(10) Pub. No.: US 2025/0059427 A1
(43) Pub. Date: Feb. 20, 2025

(54) METHOD FOR PREPARING ANTI-SINTERING CALCIUM-BASED ENERGY STORAGE MATERIAL BY VACUUM FREEZE-DRYING

(71) Applicant: FUZHOU UNIVERSITY, Fuzhou (CN)

(72) Inventors: Jinlin LONG, Fuzhou (CN); Han LI, Fuzhou (CN); Zhengxin DING, Fuzhou (CN); Na WEN, Fuzhou (CN); Pengzhao WANG, Fuzhou (CN); Jiashun WANG, Fuzhou (CN)

(73) Assignee: FUZHOU UNIVERSITY, Fuzhou (CN)

(21) Appl. No.: 18/777,635

(22) Filed: Jul. 19, 2024

(30) Foreign Application Priority Data
Aug. 16, 2023 (CN) 202311029516.4

(51) Int. Cl. C09K 5/16; C01F 11/04

(52) U.S. Cl. CPC C09K 5/16; C01F 11/04; C01P 2002/52

(57) ABSTRACT

Disclosed is a method for preparing the anti-sintering calcium-based energy storage material by vacuum freeze-drying, which includes preparation of a precursor solution by mixing a calcium salt and a metal salt of manganese, magnesium, iron, cobalt, aluminum, zirconium, titanium, chromium, nickel, lanthanum, yttrium, molybdenum, or other metals in deionized water, vacuum freeze-drying of the precursor solution to obtain fluffy powder, and calcination of the powder in an air atmosphere to obtain the anti-sintering calcium-based energy storage material. The preparation method of the present invention does not require special equipment and harsh conditions, and has strong operability. The prepared calcium-based energy storage materials feature strong stability, high energy storage capacity, etc., and can be used in industrial production.

### CROSS REFERENCE TO THE RELATED APPLICATIONS

This application is based upon and claims priority to Chinese Patent Application No. 202311029516.4, filed on Aug. 16, 2023, the entire contents of which are incorporated herein by reference.

### TECHNICAL FIELD

The present invention relates to the field of preparation of solar energy storage materials, and in particular, to a method for preparing an anti-sintering calcium-based energy storage material by vacuum freeze-drying.

### BACKGROUND

The 21st century is facing problems such as energy shortage and greenhouse effect. The large-scale development and utilization of solar energy will become an effective way to solve the above problems. Calcium-based thermal energy storage is considered one of the most promising technologies. It is based on a reversible calcium carbonate decomposition reaction (CaCO₃⇄CaO+CO₂), with the forward reaction focusing sunlight through a condenser to heat and decompose CaCO₃, thereby converting light energy into chemical energy for storage, and the reverse reaction combining CO₂ with CaO to generate CaCO₃, thereby releasing heat and converting the heat into electrical energy. Moreover, calcium-based materials, owing to their advantages of nontoxicity, rich natural content, and low price, will have broad application prospects. However, existing calcium-based materials in the prior art sinter under long-term cyclic heat release, resulting in a significant decrease in the materials' energy storage density and poor anti-sintering performance, which greatly limits their practical application.

### SUMMARY

In view of the above technical problems in the prior art, the present invention is intended to provide a simple, affordable, and highly stable method for preparing a calcium-based energy storage material to promote the application of calcium-based energy storage materials.

To achieve the foregoing objective, a technical solution adopted by the present invention is as follows:
a method for preparing an anti-sintering calcium-based energy storage material by vacuum freeze-drying, including the following steps:
1) preparation of a precursor solution: dissolve a calcium salt, a doped metal salt, and a pore-forming agent in deionized water, and stir a mixture thereof thoroughly to obtain a clear and transparent precursor solution;
2) vacuum freeze-drying of the precursor solution: freeze the precursor solution obtained in the step 1) in a low-temperature environment, and then perform vacuum freeze-drying in a vacuum freeze dryer to obtain fluffy powder; and
3) calcination of the powder: calcine the powder obtained in the step 2) in an air atmosphere to obtain the anti-sintering calcium-based energy storage material.

Further, a molar ratio of the calcium salt, the doped metal salt, and the pore-forming agent used in the step 1) is (100:1:0)-(100:80:50).

Further, the calcium salt is any one of calcium acetate, calcium nitrate, calcium citrate, calcium gluconate, calcium chloride, and calcium sulfate.

Further, the doped metal salt is an acetate, nitrate, chloride, or sulfate of one or more of manganese, magnesium, iron, cobalt, aluminum, zirconium, titanium, chromium, nickel, lanthanum, yttrium, and molybdenum.

Further, the pore-forming agent is any one of polymethyl methacrylate (PMMA), polystyrene (PS), ethylenediaminetetraacetic acid (EDTA), poly(ethylene glycol)-block-poly(propylene glycol)-block-poly(ethylene glycol) (P123), and citric acid.

Further, a total concentration of metal elements in the precursor solution obtained in the step 1) is 0.01 mol/L-10 mol/L.

Further, the low temperature environment in the step 2) is obtained through direct freezing, vacuum evaporation freezing, spray freezing, etc. in a temperature range of −70° C.-0° C.

Further, the vacuum freeze-drying in the step 3) is performed under a pressure of 0 MPa-80 MPa and at a temperature of −100° C.-0° C. for 1 d-5 d.

Further, the calcination in the step 3) is performed at a heating rate of 1° C./min-50° C./min and at a temperature of 500° C.-1000° C. for 0.5 h-4 h.

The prepared anti-sintering calcium-based thermal energy storage material can be applied to solar photothermal conversion.

Compared with the prior art, the present invention has the following beneficial effects:
(1) compared with other preparation methods, the calcium-based energy storage materials prepared by the vacuum freeze-drying method have a loose and porous structure and contains abundant pores, which can promote the diffusion of CO₂, and this preparation method can enhance the uniformity of distribution of various metal elements in the material, thereby improving the stability and anti-sintering effect of the calcium-based energy storage materials;
(2) compared with pure calcium carbonate, the calcium-based energy storage materials prepared in the present invention have characteristics of high energy storage capacity and good cyclic stability; and
(3) the preparation method of the present invention does not require special equipment and harsh conditions, featuring strong operability and convenient application.

### BRIEF DESCRIPTION OF THE DRAWINGS

FIG. 1 is a scanning electron microscope image of a calcium-based energy storage material Mn₈Zr₂₂ prepared in a Comparative Example 3;

FIG. 2 is an N₂ adsorption-desorption isotherm of the calcium-based energy storage material Mn₈Zr₂₂ prepared in the Comparative Example 3;

FIG. 3 is a cyclic thermal stability test chart of the calcium-based energy storage material Mn₈Zr₂₂ prepared in the Comparative Example 3;

FIG. 4 is a cyclic thermal stability test chart of a calcium-based energy storage material Mn₂Zr_{5.5} prepared in a Comparative Example 1;

FIG. 5 is a scanning electron microscope image of a calcium-based energy storage material Mn₈Zr₂₂ prepared in a Comparative Example 2;

FIG. 6 is an N₂ adsorption-desorption isotherm of the calcium-based energy storage material Mn₈Zr₂₂ prepared in the Comparative Example 2;

FIG. 7 is a diffuse reflectance spectroscopy (DRS) image of the calcium-based energy storage material Mn₈Zr₂₂ prepared in the Comparative Example 2; and

FIG. 8 is a cyclic thermal stability test chart of the calcium-based energy storage material Mn₈Zr₂₂ prepared in the Comparative Example 2.

### DETAILED DESCRIPTION OF THE EMBODIMENTS

A method for preparing an anti-sintering calcium-based energy storage material by vacuum freeze-drying, including the following steps:
1) preparation of a precursor solution: dissolve a calcium salt, a doped metal salt, and a pore-forming agent at a molar ratio of (100:1:0)-(100:80:50) in deionized water, and stir a mixture thereof thoroughly to obtain a clear and transparent precursor solution with a concentration of metal elements being 0.01 mol/L-10 mol/L;
2) vacuum freeze-drying of the precursor solution: freeze the precursor solution obtained in the step 1) in a low-temperature environment at −70° C.-0° C., and then perform vacuum freeze-drying in a vacuum freeze dryer under a pressure of 0 MPa-80 MPa and at a temperature of −100° C.-0° C. for 1 d-5 d to obtain fluffy powder; and
3) calcination of the powder: heat the powder obtained in the step 2) to 500° C.-1000° C. in an air atmosphere at a heating rate of 1° C./min-50° C./min and calcine it for 0.5 h-4 h to obtain the anti-sintering calcium-based energy storage material.

The calcium salt is any one of calcium acetate, calcium nitrate, calcium citrate, calcium gluconate, calcium chloride, and calcium sulfate. The doped metal salt is an acetate, nitrate, chloride, or sulfate of one or more of manganese, magnesium, iron, cobalt, aluminum, zirconium, titanium, chromium, nickel, lanthanum, yttrium, and molybdenum. The pore-forming agent is any one of polymethyl methacrylate (PMMA), polystyrene (PS), ethylenediaminetetraacetic acid (EDTA), poly(ethylene glycol)-block-poly(propylene glycol)-block-poly(ethylene glycol) (P123), and citric acid.

To make the content of the present invention easier to understand, the technical solution of the present invention will be further described below in conjunction with embodiments, but the present invention is not limited thereto.

The salts used below are all hydrate salts.

The prepared calcium-based thermal energy storage material was subjected to a cyclic test in a thermogravimetric analyzer as follows: a small amount of sample placed in an alumina pan was first heated to 800° C. at a heating rate of 20° C./min in an N₂ flow (20 mL/min), and then calcined for 4 min, and finally carbonated at 800° C. for 7 min by adding a CO₂ flow of 80 mL/min to the N₂ flow. Each repetition of carbonation and calcination was considered as 1 cycle.

### Comparative Example 1 Pure Calcium Carbonate Energy Storage Material

(1) preparation of a precursor solution: 2 g of calcium acetate was dissolved in 5 mL of deionized water, and a mixture thereof was stirred thoroughly to obtain a clear and transparent precursor solution;
(2) vacuum freeze-drying of the precursor solution: the obtained precursor solution was frozen in a low-temperature environment at −20° C., and then the obtained solid sample was subjected to vacuum freeze-drying in a vacuum freeze dryer under a pressure of 0.001 MPa and at a temperature of −30° C. for 3 d to obtain fluffy powder; and
(3) calcination of the powder: the powder obtained in the step (2) was heated to 800° C. in an air atmosphere at a heating rate of 30° C./min and calcined for 2 h to obtain a pure calcium carbonate energy storage material.

### Comparative Example 2 Anti-sintering Calcium-based Energy Storage Material Mn₂Zr_{5.5}

(1) preparation of a precursor solution: 1.85 g of calcium acetate, 0.05557 g of manganese acetate, and 0.16 mL of zirconium acetate solution (99.99 wt. %) were dissolved in 5 mL of deionized water, and a mixture thereof was stirred thoroughly to obtain a clear and transparent precursor solution;
(2) drying of the precursor solution: the obtained precursor solution was dried in an oven at 60° C. for 3 d to obtain powder; and
(3) calcination of the powder: the powder obtained in the step (2) was heated to 800° C. in an air atmosphere at a heating rate of 30° C./min and calcined for 2 h to obtain a calcium-based energy storage material Ca_{92.5}Mn₂Zr_{5.5}.

### Comparative Example 3 Doped Anti-sintering Calcium-based Energy Storage Material Mn₈Zr₂₂

(1) preparation of a precursor solution: 1.4 g of calcium acetate, 0.2226 g of manganese acetate, and 0.6393 mL of zirconium acetate solution (99.99 wt. %) were dissolved in 10 ml of deionized water, and a mixture thereof was stirred thoroughly to obtain a clear and transparent precursor solution;
(2) drying of the precursor solution: the obtained precursor solution was dried in an oven at 60° C. for 3 d to obtain powder; and

(3) calcination of the powder: the powder obtained in the step (2) was heated to 800° C. in an air atmosphere at a heating rate of 30° C./min and calcined for 2 h to obtain a calcium-based energy storage material Ca₇₀Mn₈Zr₂₂.

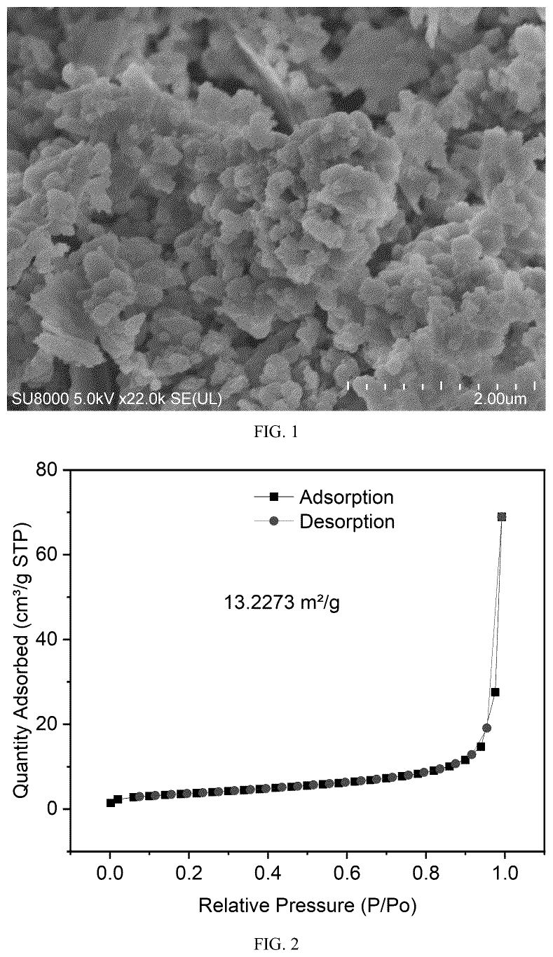

FIG. 1 is a scanning electron microscope image of the calcium-based thermal energy storage material Mn₈Zr₂₂ prepared in the Comparative Example 3. It can be seen from the figure that the calcium-based material suffered from obvious sintering.

FIG. 2 is an N₂ adsorption-desorption isotherm of the calcium-based energy storage material Mn₈Zr₂₂ prepared in the Comparative Example 3. It can be seen from the figure that the specific surface area of the material can reach 13.2273 m²/g.

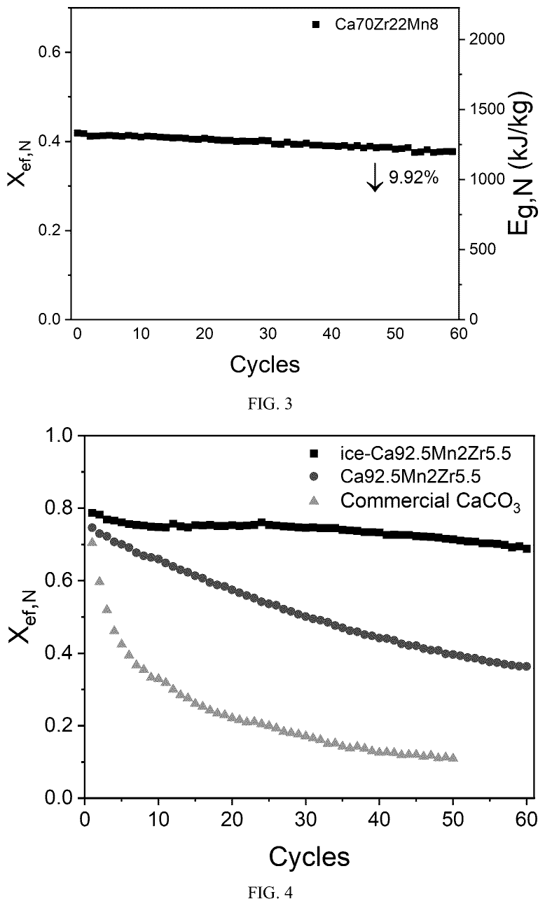

FIG. 3 is a cyclic thermal stability test chart of the calcium-based thermal energy storage material Mn₈Zr₂₂ prepared in the Comparative Example 3. It can be seen from the figure that after 60 cycles, the energy storage density of the material dropped by 9.92%.

### Example 1 Anti-sintering Calcium-based Energy Storage Material Mn₂Zr_{5.5}

(1) preparation of a precursor solution: 1.85 g of calcium acetate, 0.05557 g of manganese acetate, and 0.16 mL of zirconium acetate solution (99.99 wt. %) were dissolved in 5 mL of deionized water, and a mixture thereof was stirred thoroughly to obtain a clear and transparent precursor solution;
(2) vacuum freeze-drying of the precursor solution: the obtained precursor solution was frozen in a low-temperature environment at −20° C., and then the obtained solid sample was subjected to vacuum freeze-drying in a vacuum freeze dryer under a pressure of 0.001 MPa and at a temperature of −30° C. for 3 d to obtain fluffy powder; and
(3) calcination of the powder: the powder obtained in the step (2) was heated to 800° C. in an air atmosphere at a heating rate of 30° C./min and calcined for 2 h to obtain a calcium-based energy storage material Ca_{92.5}Mn₂Zr_{5.5}.

FIG. 4 is a cyclic thermal stability test chart of the calcium-based thermal energy storage material Mn₂Zr_{5.5} prepared in the Example 1. It can be seen from the figure that after 60 cycles, the stability of the obtained material is better than that of the pure calcium carbonate-based energy storage material prepared in the Comparative Example 1 and the calcium-based thermal energy storage material Mn₂Zr_{5.5} prepared in the Comparative Example 2, which proves that the vacuum freeze-drying method is beneficial to improving the stability of the material.

### Example 2 Doped Anti-sintering Calcium-based Energy Storage Material Mn₈Zr₂₂

(1) preparation of a precursor solution: 1.4 g of calcium acetate, 0.2226 g of manganese acetate, and 0.6393 mL of zirconium acetate solution (99.99 wt. %) were dissolved in 10 mL of deionized water, and a mixture thereof was stirred thoroughly to obtain a clear and transparent precursor solution;
(2) vacuum freeze-drying of the precursor solution: the obtained precursor solution was frozen in a low-temperature environment at −20° C., and then the obtained solid sample was subjected to vacuum freeze-drying in a vacuum freeze dryer under a pressure of 0.001 MPa and at a temperature of −30° C. for 3 d to obtain fluffy powder; and
(3) calcination of the powder: the powder obtained in the step (2) was heated to 800° C. in an air atmosphere at a heating rate of 30° C./min and calcined for 2 h to obtain a calcium-based energy storage material Ca₇₀Mn₈Zr₂₂.

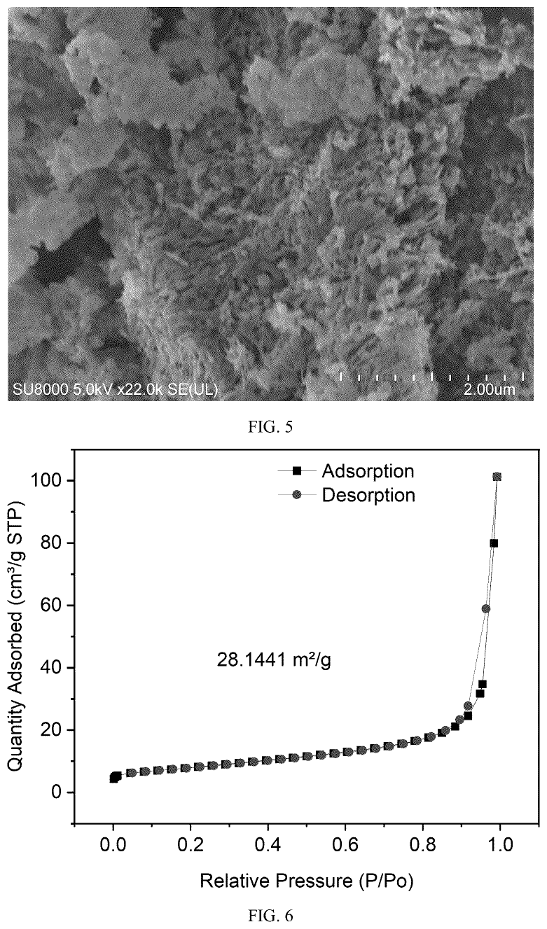

FIG. 5 is a scanning electron microscope image of the calcium-based thermal energy storage material Mn₈Zr₂₂ prepared in the Example 2. It can be seen from the figure that the material has a loose and porous structure.

FIG. 6 is an N₂ adsorption-desorption isotherm of the calcium-based energy storage material Mn₈Zr₂₂ prepared in the Example 2. It can be seen from the figure that the specific surface area of the material can reach 28.1441 m²/g.

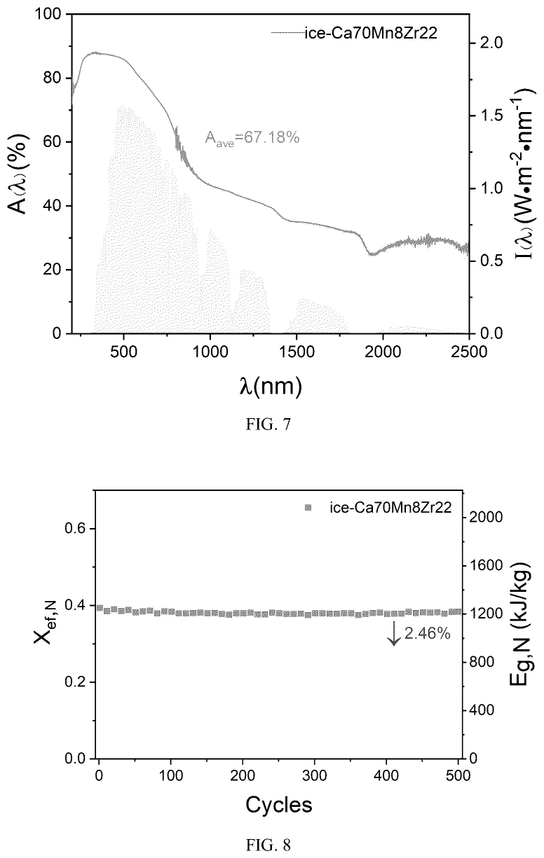

FIG. 7 is a diffuse reflectance spectroscopy (DRS) image of the calcium-based thermal energy storage material Mn₈Zr₂₂ prepared in the Example 2. It can be seen from the figure that the average sunlight absorption rate of the material can reach 67.18%.

FIG. 8 is a cyclic thermal stability test chart of the calcium-based thermal energy storage material Mn₈Zr₂₂ prepared in the Example 2. It can be seen from the figure that after 500 cycles, the energy storage density of the material was stabilized at 1200 KJ/kg, dropping by only 2.46%, which proves that as the doping content increases, the stability of the material is greatly improved, and the material has excellent anti-sintering performance and cyclic stability.

### Example 3 Doped Anti-sintering Calcium-based Energy Storage Material Mn₅Mg₁₅

(1) preparation of a precursor solution: 1.6 g of calcium acetate, 0.1391 g of manganese acetate, 0.3653 g of magnesium acetate, 2 g of citric acid were dissolved in 5 mL of deionized water, and a mixture thereof was stirred thoroughly to obtain a clear and transparent precursor solution;

(2) vacuum freeze-drying of the precursor solution: the precursor solution was frozen in a low-temperature environment at −20° C., and then the obtained solid sample was subjected to vacuum freeze-drying in a vacuum freeze dryer under a pressure of 0.001 MPa and at a temperature of −30° C. for 3 d to obtain fluffy powder; and

(3) calcination of the powder: the powder obtained in the step (2) was heated to 800° C. in an air atmosphere at a heating rate of 30° C./min and calcined for 2 h to obtain a calcium-based energy storage material Ca₇₀Mn₅Mg₁₅.

### Example 4 Doped Anti-sintering Calcium-based Energy Storage Material Mn₈Mg₆Ni₄

The preparation method is the same as that in the Example 1, except that in the step 1), 1.6 g of calcium acetate, 0.2226 g of manganese acetate, 0.1948 g of magnesium acetate, and 0.113 g of nickel acetate were dissolved in 15 mL of water.

### Example 5 Doped Anti-sintering Calcium-based Energy Storage Material Mn₅Co₅Mg₁₀

The preparation method is the same as that in the Example 1, except that in the step 1), 1.6 g of calcium acetate, 0.1391 g of manganese acetate, 0.149 g of cobalt acetate, 0.2435 g of magnesium acetate, and 1 g of P123 were dissolved in 15 mL of water.

### Example 6 Doped Anti-sintering Calcium-based Energy Storage Material Mn₅Al₅

The preparation method is the same as that in the Example 1, except that in the step 1), 1.8 g (0.01 mol) of calcium acetate, 0.1391 g of manganese acetate, and 0.081 g (0.001 mol) of aluminum iron acetate were dissolved in 10 mL of water.

### Example 7 Doped Anti-sintering Calcium-based Energy Storage Material Mn₅La₅

The preparation method is the same as that in the Example 1, except that in the step 1), 1.8 g of calcium acetate, 0.1391 g of manganese acetate, and 0.67 g of lanthanum acetate were dissolved in 10 mL of water.

### Example 8 Doped Anti-sintering Calcium-based Energy Storage Material Mn₅Fe₃Mg₅

The preparation method is the same as that in the Example 1, except that in the step 1), 1.76 g of calcium acetate, 0.1391 g of manganese acetate, 0.107 g of magnesium acetate, and 0.058 g of iron acetate were dissolved in 10 mL of water.

### Example 9 Doped Anti-sintering Calcium-based Energy Storage Material Mn₅Co₃Mg₅

The preparation method is the same as that in the Example 1, except that in the step 1), 1.76 g of calcium acetate, 0.1391 g of manganese acetate, 0.107 g of magnesium acetate, and 0.075 g of cobalt acetate were dissolved in 10 mL of water.

### Example 10 Doped Anti-sintering Calcium-based Energy Storage Material Mn₅Co₅Al₅

The preparation method is the same as that in the Example 1, except that in the step 1), 1.76 g of calcium acetate, 0.1391 g of manganese acetate, 0.075 g of cobalt acetate, 0.081 g of aluminum acetate, and 2 g of EDTA were dissolved in 10 mL of water.

The above-described embodiments are only exemplary embodiments of the present invention, and all equivalent changes and modifications made in accordance with the claims of the present invention shall fall within the scope of the present invention.

What is claimed is:

1. A method for preparing an anti-sintering calcium-based energy storage material by a vacuum freeze-drying, comprising the following steps:
1) a preparation of a clear and transparent precursor solution: dissolving a calcium salt, a doped metal salt, and a pore-forming agent in deionized water to obtain a mixture, and stirring the mixture thoroughly to obtain the clear and transparent precursor solution;
2) the vacuum freeze-drying of the clear and transparent precursor solution: freezing the clear and transparent precursor solution obtained in the step 1) in a low-temperature environment, and then performing the vacuum freeze-drying to obtain fluffy powder; and
3) a calcination of the fluffy powder: calcining the fluffy powder obtained in the step 2) in an air atmosphere to obtain the anti-sintering calcium-based energy storage material.

2. The method for preparing the anti-sintering calcium-based energy storage material by the vacuum freeze-drying according to claim 1, wherein a molar ratio of the calcium salt, the doped metal salt, and the pore-forming agent used in the step 1) is (100:1:0)-(100:80:50).

3. The method for preparing the anti-sintering calcium-based energy storage material by the vacuum freeze-drying according to claim 1, wherein the calcium salt is one of calcium acetate, calcium nitrate, calcium citrate, calcium gluconate, calcium chloride, and calcium sulfate.

4. The method for preparing the anti-sintering calcium-based energy storage material by the vacuum freeze-drying according to claim 1, wherein the doped metal salt is an acetate, nitrate, chloride, or sulfate of one or more of manganese, magnesium, iron, cobalt, aluminum, zirconium, titanium, chromium, nickel, lanthanum, yttrium, and molybdenum.

5. The method for preparing the anti-sintering calcium-based energy storage material by the vacuum freeze-drying according to claim 1, wherein the pore-forming agent is one of polymethyl methacrylate (PMMA), polystyrene (PS), ethylenediaminetetraacetic acid (EDTA), poly(ethylene glycol)-block-poly(propylene glycol)-block-poly(ethylene glycol) (P123), and citric acid.

6. The method for preparing the anti-sintering calcium-based energy storage material by the vacuum freeze-drying according to claim 1, wherein a total concentration of metal elements in the clear and transparent precursor solution obtained in the step 1) is 0.01 mol/L-10 mol/L.

7. The method for preparing the anti-sintering calcium-based energy storage material by the vacuum freeze-drying according to claim 1, wherein a temperature range of the low-temperature environment in the step 2) is −70° C.-0° C.

8. The method for preparing the anti-sintering calcium-based energy storage material by the vacuum freeze-drying according to claim 1, wherein the vacuum freeze-drying in the step 2) is performed under a pressure of 0 MPa-80 MPa and at a temperature of −100° C.-0° C. for 1 d-5 d.

9. The method for preparing the anti-sintering calcium-based energy storage material by the vacuum freeze-drying according to claim 1, wherein the calcination in the step 3) is performed at a heating rate of 1° C./min−50° C./min and at a temperature of 500° C.-1000° C. for 0.5 h-4 h.

10. An anti-sintering calcium-based energy storage material prepared by the method according to claim 1.

11. The method for preparing the anti-sintering calcium-based energy storage material by the vacuum freeze-drying according to claim 2, wherein the calcium salt is one of calcium acetate, calcium nitrate, calcium citrate, calcium gluconate, calcium chloride, and calcium sulfate.

12. The method for preparing the anti-sintering calcium-based energy storage material by the vacuum freeze-drying according to claim 2, wherein the doped metal salt is an acetate, nitrate, chloride, or sulfate of one or more of manganese, magnesium, iron, cobalt, aluminum, zirconium, titanium, chromium, nickel, lanthanum, yttrium, and molybdenum.

13. The method for preparing the anti-sintering calcium-based energy storage material by the vacuum freeze-drying according to claim 2, wherein the pore-forming agent is one of polymethyl methacrylate (PMMA), polystyrene (PS), ethylenediaminetetraacetic acid (EDTA), poly(ethylene glycol)-block-poly(propylene glycol)-block-poly(ethylene glycol) (P123), and citric acid.
